(19) United States
(12) Patent Application Publication
(10) Pub. No.: US 2009/0025075 A1
(43) Pub. Date: Jan. 22, 2009

(54) On-demand authentication of call session party information during a telephone call

(75) Inventors: Stanley Taihai Chow, Ottawa (CA); Vinod Choyi, Ottawa (CA); Christophe Gustave, Ottawa (CA); Dmitri Vinokurov, Ottawa (CA)

Correspondence Address: GALASSO & ASSOCIATES, LP, P.O. BOX 26503, AUSTIN, TX, 78755-0503, US

(73) Assignee: ALCATEL LUCENT

(21) Appl. No.: 11/879,307

(22) Filed: Jul. 17, 2007

(51) Int. Cl. G06F 7/04

(52) U.S. Cl. 726/10

(57) ABSTRACT

A method comprises a plurality of operations. An operation is performed for requesting authentication of a target call session party during a call session between the target party and a call session party requesting said authentication. An operation is performed for receiving authentication information of the target call session party during the call session in response to requesting said authentication. An operation is performed for facilitating authentication of said authentication information during the call session in response to receiving said authentication information.

### FIELD OF THE DISCLOSURE

The disclosures made herein relate generally to authentication provisions in telephony network systems and, more particularly, to on-demand authentication of call session party information during a telephone call.

### BACKGROUND

Identity theft has also become a serious problem nearly everywhere in the world. For example, the United States Justice Department estimated in 2002 that up to 700,000 people in the United States were victimized by identity thieves, while more recent analyses place the estimates much higher. Fraud related to identity theft schemes is becoming very prevalent in today's intricate telephony (e.g., voice/data) networks Malicious entities are taking advantage of well-established social behavior to gather sensitive information.

These malicious entities leverage a false sense of security that telephony users have when it comes to phone systems, thereby tricking phone users into disclosing confidential information. For example, situation are well-known and widespread where a calling party attempts to obtain confidential information from a called party for the purpose of committing malicious acts (e.g., criminal and/or deceitful acts) with such confidential information. While less well-known, the situation also exists where a called party can attempt to obtain confidential information from a calling party for the purpose of committing malicious acts with such confidential information even though the calling party initiated the call to the called party. Accordingly, there are many scenarios where it is desirable for the calling party to authenticate the identity of a called party, even though the calling party controls the number called. One scenario is where the called number may have been wrongly associated to a 3^{rd} party entity, for example via an email phishing scam. Another scenario is where the called number may be a shared number in location such as, for example, a dormitory floor or room, a factory floor and the like. Another scenario is where the called number properly reaches a receptionist phone line of a receptionist who may not be trustworthy. Another scenario is where the called number properly reaches a corresponding home phone line, but a specific individual is the actual intended called party such as, for example, due to reasons of confidential information handling regulations (e.g., financial or medical information). Another scenario is where the called number is that of a cell phone that may or may not be in the immediate possession of the cell phone owner. Another scenario is where the called number may be unknown to a calling party (e.g., a number left on an answering machine of a phone number that the calling party has called). Another scenario is where the called number may have been accidentally or maliciously forwarded to another number. Another scenario is where, in high security contexts (e.g., military), there may be regulatory reasons to positively identify a called party. Such malicious activities, whether committed by the called party of the calling party, are referred to as “phishing” attacks.

With the advent of Voice over Internet Protocol (VoIP), telephony networks are becoming more open to such phishing attacks that can damage customer to business relationships and ultimately lead to direct financial loss for both parties. Existing authentication approaches are configured for attempting to authenticate the calling party for all calls. This is normally done in the call setup phase. Triggering such an authentication function for all incoming calls generally an unnecessary overload for the resources involved in the authentication process and also for network bandwidth. In fact, in many cases, the called party will typically want to authenticate only a small subset of their incoming phone call. The same can be said with respect to authentication of called parties by calling parties.

Therefore, a solution that allows a party in a telephone session to authenticate information associated with another party of the telephone session in an on-demand manner would be advantageous, desirable and useful.

### SUMMARY OF THE DISCLOSURE

Embodiments of the present invention address the problem of a first call session party attempting to obtain confidential information from a second call session party during a call session for the purpose of committing malicious acts with such confidential information. More specifically, embodiments of the present invention provide for authentication of information (e.g., identity information) corresponding to one of a target call session party at the request of a requesting call session party. Through such authentication, the requesting call session party can be reasonably assured that they are truly engaging in a telephony-based communication session (i.e., a telephone call) with a call session party they believe they are conversing with and have provided thereto valuable information about that call session party, thereby reducing the potential for unknowingly partaking in fraudulent or malicious activities.

In one embodiment of the present invention, a method comprises a plurality of operations. An operation is performed for requesting authentication of a target call session party during a call session between the target party and a call session party requesting said authentication. An operation is performed for receiving authentication information of the target call session party during the call session in response to requesting said authentication. An operation is performed for facilitating authentication of said authentication information during the call session in response to receiving said authentication information.

In another embodiment of the present invention, a server comprises various processor-executable instructions. Processor-executable instructions are provided for requesting authentication of a target call session party during a call session between the target party and a call session party requesting said authentication. Processor-executable instructions are provided for receiving authentication information of the target call session party during the call session in response to requesting said authentication. Processor-executable instructions are provided for facilitating authentication of said authentication information during the call session in response to receiving said authentication information.

In another embodiment of the present invention, a telephony network system is configured to request authentication of a target call session party during a call session between the target party and a call session party requesting said authentication, to receive authentication information of the target call session party during the call session in response to requesting said authentication; and to facilitate authentication of said authentication information during the call session in response to receiving said authentication information.

These and other objects, embodiments, advantages and/or distinctions of the present invention will become readily apparent upon further review of the following specification, associated drawings and appended claims.

### BRIEF DESCRIPTION OF THE DRAWINGS

FIGS. 1A-1C are a flow chart showing an embodiment of a method for facilitating on-demand call session party authentication functionality in accordance with the present invention.

FIG. 2 is a schematic diagram of a registration infrastructure and process for information provider registration in accordance with the present invention.

FIG. 3 is a schematic diagram showing a first embodiment of an information identity authentication infrastructure and process performed by a user device executing an identification information authentication application in accordance with the present invention.

FIG. 4 is a schematic diagram showing a second embodiment of an information identity authentication infrastructure and process performed by a user device executing an identification information authentication application in accordance with the present invention.

FIG. 5 is a schematic diagram showing a third embodiment of an information identity authentication infrastructure and process performed by a user device executing an identification information authentication application in accordance with the present invention.

FIGS. 6a-6c are schematic diagrams of an information recipient device displaying identification information authentication messages in accordance with the present invention.

FIGS. 7a-7d are schematic diagrams of different methods of conveying caller authentication indications to information recipient devices.

### DETAILED DESCRIPTION OF THE DRAWING FIGURES

The present invention provides a method for on-demand authentication of call session party information during a telephone call, thus thwarting threats related to spoofing of user identity. Specifically, the invention is directed to enabling a party in a telephone session (i.e., the called party or the calling party) to authenticate information associated with another party of the telephone session in an end-to-end on-demand manner on a per call basis. A registry holds authenticated identification information of the party to be authenticated. The party being authenticated must first register identification information to the registry. Upon successful registration, the registry (i.e., operating as a certificate authority) signs the certificate embedded with the identification and the public key of the called party. Upon call set-up, the authenticating party in the telephone session uses a means such as, for example, an asymmetric key cryptographic function to authenticate information associated with the other party. Accordingly, the present invention provides for on-demand authentication of conversation parties (either human or machine) that gives a called party and/or calling party the choice to trigger on-demand call session party authentication functionality at anytime during the course of a telephone conversation.

On-demand call session party authentication functionality in accordance with the present invention provides for authentication of users in a telephone call session upon request. Whenever a first party in such a session wants to authenticate a second party in the session, the first party triggers an authentication request function on their telephony apparatus (i.e., Party A telephony apparatus). The request triggers an exchange between the Party A telephony apparatus and telephony apparatus of the second (i.e., Party B telephony apparatus), resulting in authenticated information being displayed. The authentication can be applied to the line, to the phone, to the display name of the user, to the user.

As a skilled person will appreciate, on-demand call session party authentication functionality in accordance with the present invention has a number of advantages. One advantage is that such on- demand call session party authentication functionality allows a party in a call session to discriminate against the calls he/she may want to authenticate. The call session party may trigger the on-demand call session party authentication functionality at any point in time during a call whenever they are certain that they require associated authenticated information, thus making the solution user-centric and giving the user total control over this capability. Another advantage is that such on-demand call session party authentication functionality will reduce the number of calls to be authenticated, solving crucial performance issues on the network elements and end user devices involved in the authentication process. This is extremely beneficial, as strong factor authentication typically requires extensive computational power. Still another advantage is that such on-demand call session party authentication functionality will also prevent network congestion problems that may arise in the course of the authentication process. This is especially true in the case of transmitting authentication data such as, for example, X509 certificates.

A skilled person will further appreciate that on-demand call session party authentication functionality in accordance with the present invention productively and effectively addresses the situation where a call session party has the need to authenticate information associated with a small subset of their entire volume of calls. This is even more beneficial in the case where a service provider (e.g., an Internet service provider) charges an extra fee for each authenticated call. Without such a per-call fee option, a call session party may not want to subscribe to an authentication service if they only have the need authenticate services for a few call sessions per month or even per year. On-demand call session party authentication functionality in accordance with the present invention will allow call session parties to subscribe to an authentication service and be charged on a per authenticated call basis. In many if not most cases, a call session party will not want to pay an extra fee for calls that do not need to be authenticated. Furthermore, implementation of on-demand call session party authentication functionality in accordance with the present invention limits the occurrence and/or potential for degradation of networking Quality of Service (QoS), while rendering to call session parties the service that they would normally expect.

In one embodiment of on-demand call session party authentication functionality in accordance with the present invention, the party initiating the call session party authentication functionality triggers such functionality using a specially labeled button on a phone (i.e., selecting a prescribed input element). Such an approach is user-friendly but requires phones specifically configured for triggering on-demand call session party authentication functionality in accordance with the present invention. This approach is particularly useful for phones that are also configured for carrying out on-demand call session party authentication functionality in its entirety, thus allowing the phone to provide for such on-demand call session party authentication functionality independently of any Telco equipment or network infrastructure.

In another embodiment of on-demand call session party authentication functionality in accordance with the present invention, the user can also initiate the request via a specific sequence of keys on the phone (e.g. pressing *123), which is also referred to herein as providing a prescribed activation code. This embodiment allows existing phones to be used, relying on downstream equipment (e.g., the local PBX, or the Telco central office) to process information and commands for associated with on-demand call session party authentication functionality in accordance with the present invention. In response to activating the on-demand call session party authentication functionality by pressing the sequence of keys on a keypad of the phone of a first party in a call session (i.e., triggering the on-demand call session party authentication functionality), corresponding dual-tone multi-frequency (DTMF) signaling generated by the phone are decoded by downstream equipment, e.g. in the PBX or at the telephone company's central office. The decoded DTMF signaling instructs the downstream equipment to facilitate authentication of information associated with a second party in the call session. DTMF signaling is typically used for telephone signaling over the line in the voice-frequency band to the call-switching center. The version of DTMF used for telephone tone dialing is commonly known by the trademarked term Touch-Tone, and is standardized by ITU-T Recommendation Q.23.

The exchange of messages needed to perform on-demand call session party authentication functionality (i.e., on-demand authentication messages) in accordance with the present invention can be transmitted in multiple ways, which include in the signaling path, in the voice path (also called data path or media path), or completely out-of-band. The signaling path is useful for cases like VoIP where the signaling channel stays active throughout the call. The voice path is useful for cases like PSTN when the signaling path is explicitly hidden from the users. Being carried in the voice path means the message is encoded into tones that are carried in the established voice channel and that in-band transmission is only an option after the voice path is already set up. Because the trigger travels in the voice channel, the far end can automatically associate the request with the correct call.

The on-demand authentication messages can be encoded into DTMF tones. These messages can also be encoded into standard modem tones (e.g., ITU v.92 standard for 56 Kbits). The messages can also be encoded into “Data Under Voice” by using spread-spectrum or other encodings. Clearly, DTMF encoding is very simple and can use existing equipment. But, signaling via DTMF encoding but is slow, v.92 requires adding commodity hardware, and Data Under Voice requires custom hardware.

Transmitting on-demand authentication messages using an out-of-band approach entails using a channel other than the signaling and voice channels. When the out-of-band messages arrive at the far end, they must contain enough information to associate it with the correct call. For example, such an out-of-band approach could be an independent IP channel, short message service (SMS), general packet radio service (GPRS), or other suitable known and newly invented methods of signal transmission. IP channels provide a convenient transmission approach for VoIP signaling. SMS and GPRS provide a convenient transmission approach for GSM (Global System for Mobile Communications) handsets.

It is also possible to use a combination of in-band and out-of-band for transmitting on-demand authentication messages. For example, a request for on-demand authentication can be initiated with DTMF in the voice channel, with the request including an IP address and port number. This implementation of DTMF minimizes the length of the request message therefore minimizing the time required for the DTMF signaling. Subsequent messages (e.g., transmission of the authentication certificate) can be transmitted using IP over the Internet. This combined approach for transmission takes advantage of the higher speed of the Internet for bulkier messages. It is also possible to carry out negotiation, using in-band DTMF, to decide on the best out-of-band mechanism that is common to both ends.

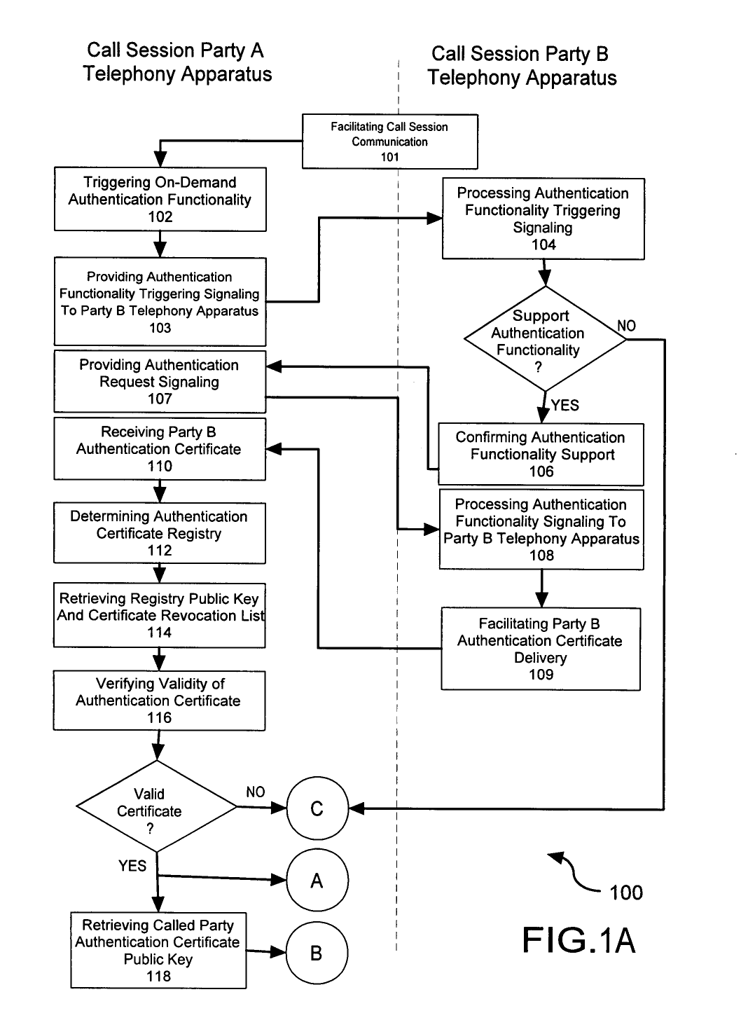

FIG. 1 shows the basic steps involved when a user triggers the authentication procedure to be handled downstream using out-of-band IP (for the locally handled case, we can skip the DTMF steps). User A, in the course of a phone dialog with user B, triggers the authentication request procedure by applying DTMF tones to the voice channel. The DTMF tones are carried by the voice channel to the PBX or the central office, which can decode the DTMF tones and detect the request. The equipment then generates an out-of-band authentication request to the phone of user B (or the PBX, central office, or other equipment acting on B's behalf). If user B does not support the authentication function, user A is notified with a message indicating the authentication failure. Otherwise, once the authentication request has been acknowledged by the equipment at the user B premises, the end-to-end authentication procedure starts between user B and user A.

FIGS. 1A-1C show a method 100 for facilitating on-demand authentication of call session party information during a telephone call. Referring to FIG. 1A, telephony apparatus of a first call session party (i.e., Party A telephony apparatus) and telephony apparatus of a second call session party (i.e., Party B telephony apparatus)jointly perform an operation 101 for facilitating call session communication (i.e., a conversation between the first and second call session parties). At some time during the call session communication, the Party A telephony apparatus performs an operation 102 for triggering (i.e., activating) on-demand call session party authentication functionality through any number of conceivable approaches (e.g., using a specially labeled button on a phone, pressing a required sequence of keys on a keypad, speaking a certain phrase, etc). In response to activating the on-demand call session party authentication functionality, an operation 103 is performed for providing authentication functionality triggering signaling corresponding to such triggering to the Party B telephony apparatus. In response, the Party B telephony apparatus performs an operation 104 for processing (e.g., decoding) the authentication functionality triggering signaling. In certain situations, it will be acceptable if not preferably for the triggering signaling to be implemented via a signaling format that is convenient and simple as opposed to being efficient from a network overhead standpoint (e.g., DTMF tones).

If the Party B telephony apparatus does not support on-demand call session party authentication functionality in accordance with the present invention, the Party B telephony apparatus performs an operation 105 for providing an authentication failure notification (i.e., an authentication failure notification), which indicates that the Party B telephony apparatus does not support on-demand call session party authentication functionality in accordance with the present invention. Examples of providing the authentication failure notification include, but are not limited to, an audible message and/or visual message indicating that the Party B telephony apparatus does not support on-demand call session party authentication functionality in accordance with the present invention. In addition to providing the authentication failure notification, it is disclosed herein that a pre-configured optional policy can dictate further action to be taken in the case of the Party B telephony apparatus not supporting on-demand call session party authentication functionality in accordance with the present invention (e.g. trigger an alarm function to appropriate network configuration management equipment). If the Party B telephony apparatus does support on-demand call session party authentication functionality in accordance with the present invention, an operation 106 is performed by the Party B telephony apparatus for confirming on-demand call session party authentication functionality support (i.e., the Party B telephony apparatus being configured for carrying out on-demand call session party authentication functionality in accordance with the present invention). In response to the Party B telephony apparatus confirming such support, the Party A telephony apparatus performs an operation 107 for providing authentication request signaling. In certain situations, it will be acceptable if not preferably for the authentication request signaling to be implemented via a signaling format that is efficient for carrying relatively bulky messages (e.g., out-of-band over the Internet).

In response to the Party B telephony apparatus performing an operation 108 for processing the authentication request signaling, the Party B telephony apparatus performs an operation 109 for facilitating delivery of an authentication certificate corresponding to authenticated information of Party B (i.e., Party B authentication certificate). For example, in one embodiment, facilitating Party B authentication certificate delivery includes accessing the Party B authentication certificate and transmitting it for reception by the Party A telephony apparatus. In another embodiment, facilitating Party B authentication certificate includes instructing a remote system or apparatus to transmit the Party B authentication certificate for reception by the Party A telephony apparatus. Accordingly, the present invention is not limited to any particular approach for facilitating delivery of the Party B authentication certificate to the Party A telephony apparatus.

In response to the Party A telephony apparatus performing an operation 110 for receiving the Party B authentication certificate, the Party A telephony apparatus performs an operation 112 for determining an authentication certificate registry that issued the Party B authentication certificate, followed by performing an operation 114 for retrieving a registry public key and certificate revocation list therefrom. Using such retrieved information, the Party A telephony apparatus performs an operation 116 for verifying validity of the Party B authentication certificate. For example, providing the Party B authentication certificate is not on the retrieved certificate revocation list, verifying authenticity of the authentication certificate include using the registry public key to determine if the Party B authentication certificate was signed by the private key of the authentication certificate registry. If it is determined that the authentication certificate is not authentic (e.g., was not signed by the registry's private key) or if the authentication certificate is on the certificate revocation list, expired, etc, the Party A telephony apparatus performs the operation 106 (or variant thereof) for providing an authentication failure notification (FIG. 1C). In addition to providing the authentication failure notification, it is disclosed herein that a pre-configured optional policy can dictate further action to be taken in the case of the authentication certificate not being successfully authenticated (e.g. trigger an alarm function to appropriate network security management equipment). If it is determined that the Party B authentication certificate is authentic (e.g., was signed by the registry's private key) and the Party B authentication certificate is not on the certificate revocation list, the Party A telephony apparatus performs the operation 118 for retrieving the public key from the Party B authentication certificate and performs an operation 120 for requesting proof from the called party that the private key corresponding to the Party B authentication certificate is in its possession (FIG. 1B).

In response to requesting such proof, the Party B telephony apparatus performs an operation 122 for responding to the request thereby causing such proof (i.e., alleged proof at this point) to be transmitted for reception by the Party A telephony apparatus. In response to such proof being sent, the Party A telephony apparatus performs an operation 124 for receiving the proof of private key possession. After receiving the proof of private key possession, the Party A telephony apparatus performs an operation 126 for verifies authenticity of such proof using the Party B authentication certificate public key.

It is disclosed herein that the second call session party can be an individual or a group of individuals (e.g., a business entity). Thus, a response to the request for proof from the second call session party that the private key corresponding to the Party B authentication certificate is in its possession can be from a specific individual or from one or more individuals authorized or capable of responding to such request. Furthermore, the response can be that of a system of the second call session party (e.g., a PBX of a business entity) or that of a telephone device (e.g., cell telephone) of the second call session party. In this manner, the response can be provided in an automated manner (e.g., by a device or system) or can be provided at the command of a person (e.g., in response to their entering a passcode that causes the required proof to be transmitted for reception by the Party A telephony apparatus).

The objective in requesting such proof is to verify that the private key corresponding to the Party B Party B authentication certificate is in possession of the called party. One embodiment of requesting such proof includes the Party A telephony apparatus generating a random number (i.e., a “nonce”) and transmitting the nonce for reception by the Party B telephony apparatus. In response to receiving the nonce, the Party B telephony apparatus encrypts the nonce with called party's private key (i.e., the private key corresponding to the Party B authentication certificate) and transmits the encrypted nonce for reception by the Party A telephony apparatus. In response to receiving the encrypted nonce, the Party A telephony apparatus uses public key retrieved from the Party B authentication certificate to decrypt the encrypted nonce. If the decrypted nonce is the same as that sent, it is assumed that the private key corresponding to the Party B authentication certificate is in the possession of the called party (e.g., in possession of the Party B telephony apparatus).

If it is determined that the provided proof of private key possession is not authentic (i.e., the proof provided does not indicate possession of the private key corresponding to the public key retrieved from the Party B authentication certificate), the Party A telephony apparatus performs the operation 106 (or variant thereof) for providing an authentication failure notification. If it is determined that the provided proof of private key possession is authentic (i.e., the proof provided does indicate possession of the private key corresponding to the public key retrieved from the Party B authentication certificate), the Party A telephony apparatus performs an operation 128 for accessing such presented identification information, followed by an operation 130 for verifying called party identification information presented by the called party against identification information retrieved from the Party B authentication certificate after. For example, in conjunction with providing the proof of private key possession, identification information (e.g., a particular name of the called party) is also provided to the Party A telephony apparatus. If it is determined that the presented identification information matches the authenticated identification information, the Party A telephony apparatus performs an operation 132 for providing authentication information to the called party (e.g., via an audio message and/or a visual message), which acknowledges successful authentication of the called party. Otherwise, the Party A telephony apparatus performs the operation 106 for providing the authentication failure notification (e.g., indicating that the presented identification information does not match the authenticated identification information). In addition to providing the authentication failure notification, it is disclosed herein that a pre-configured optional policy can dictate further action to be taken in the case of the presented identification information not matching the authenticated identification information (e.g. trigger an alarm function to a network security management equipment). For billing purpose, upon successful authentication of Party B, a function can be triggered (e.g., at the network element premises of Party A), which increments the number of authenticated calls for Party A.

As will now be discussed in greater detail, on-demand authentication of a party in a call session in accordance with the present invention relies on an authenticated call session party registry. The call session party registry may be maintained on a global level, regional level, local level or other level. The present invention is not limited to a particular range for which the registry covers. For the purposes of this disclosure, whenever a call session party (e.g., Party A or Party B) requires access to the authenticated conference call feature in a specific location area, that entity registers identification information with the local authority managing the registry of authenticated call session parties for this area or jurisdiction. Upon completion of the registration process, that entity is issued with an authentication certificate (e.g., X.509 certificate) having the identification information embedded therein and being signed by an authenticated call session party-recognized certificate authority. Phone endpoints associated with the entity are then provisioned with such authentication certificates on a per call basis to assert the authenticity of the provided call session party information in a particular jurisdiction.

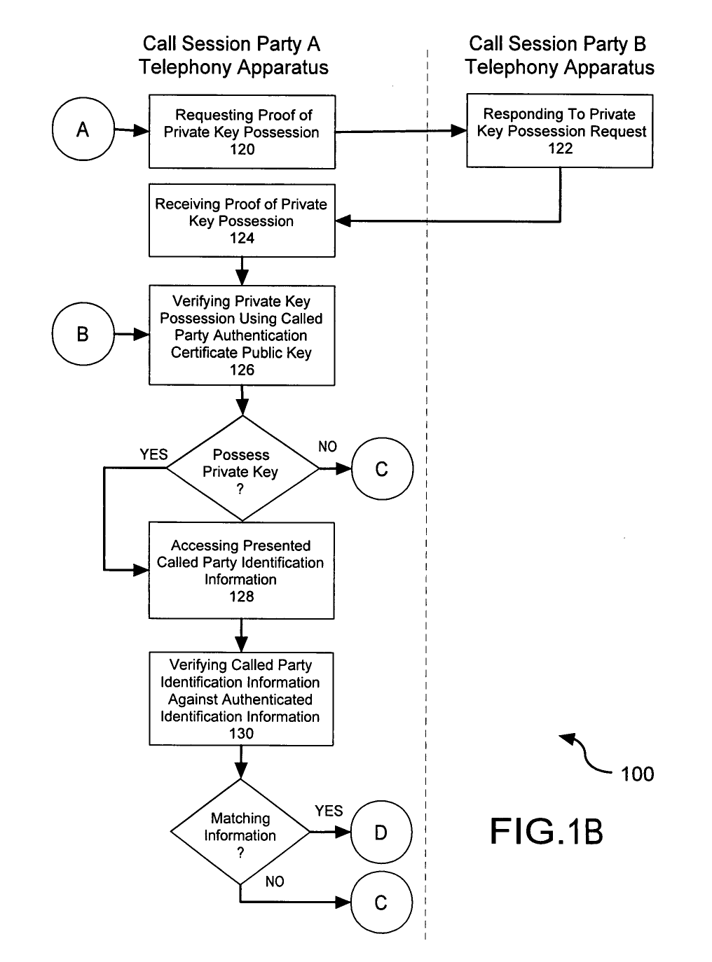

FIG. 2 is a schematic diagram of an exemplary registration infrastructure and associated process for registration of identification information in accordance with the present invention. In this example, a registrant 1110 (i.e., a call session party) registers with three separate registries: registry 1101 is operated by a registration authority (RA) that is a network service provider 1100, registry 1201 is operated by a RA that is an interest group (such as a trade association), and registry 1301 is operated by a RA that is a geographical or political region (perhaps a government or other official entity). Registrant 1110 registers in this manner to provide authenticated identification information to information recipients that subscribe to any one of the available registries. That is, registrant 1110 can be authenticated to an information recipient if and only if the information recipient subscribes to one or more of the available registries, in this example, registries 1101, 1201 or 1301.

The respective RA operates each registry. Operating a registry is defined herein to include maintaining information contained in a registry. A RA may be any public or private organization interested in providing an identification information registry. A RA does not require approval from any authority to operate, but may seek endorsement by these authorities. End-users, service suppliers, and/or equipment suppliers can determine if any given registry is trustworthy, and subscribe to only those registries determined to be trustworthy. Each registry is composed of two main parts—the RA (Certification Authority in X.509 parlance) and a database of identification information. Each registry serves a predetermined subscriber group, region and/or a predefined interest group. A region served by one registry may overlap a region served by another registry, and two or more registries may serve the same region. Similarly, two or more different defined interest groups can overlap (e.g., doctors and the more narrowly defined interest group of pediatricians).

The registry 1101 is maintained by a network service provider 1100 that wishes to provide an authenticated information provider service to any company, public or government organization, or other registrant 1110 who wishes to provide authenticated identification information to information recipients served by the network service provider 1100. The registry 1201 is operated by the interest group 1200 such as, for example, the Canadian Bankers Association®, which maintains the registry 1201 to provide authenticated identification information and/or associated services to its bank members. The registry 1301 is associated with a geographical or political region such as, for example, New York State; the Province of Ontario; the City of Toronto; the greater Chicago area; etc. and is maintained by a corresponding government agency or other official entity 1300.

In one embodiment, the only responsibility borne by the RAs 1100, 1200 or 1300 is to ensure proof of identity of any registrant 1110 and to ensure that it does not register any duplicate identification information for different registrants 1110. In this embodiment, the registry 1101 (which consists of the database and the RA) can be freely inspected by the public and it is at least partially the responsibility of registrants 1110 and other interested parties to police the registries 1101, 1201 and 1301 in order to ensure that a confusingly similar or misleading information provider identity is not registered by another registrant 1110. When a registrant 1110 is registered, the RA issues an authentication certificate 1104. The authentication certificate certifies that the registered information provider identity (i.e., identification information) is bound to a public key of the registrant, which is in turn implicitly paired with a private key of the registrant.

It is disclosed herein that, depending on implementation/deployment choices, the authentication certificate of a registrant can be either embedded into a component of a telephony apparatus (e.g., telephone device, server, etc) or embedded in an authentication token (Smartcard, USB-based device, etc) pluggable into such component of a telephony apparatus.

### Registration Process

The authentication certificate 1104 provided to each registrant 1110 by a registry can conform to any known authentication system, and each registry can use a different authentication system without departing from the scope of the present invention. When the registrant's identification information is recorded in a registry, an authentication certificate is provided to the registrant 1110 to permit information provider authentication to be performed. The authentication certificate can be based on any public key infrastructure scheme like X.509.

If X.509 certificates are used for the authentication certificates provided to the registrants 1110, in one embodiment of the present invention, the registration process proceeds as follows (i.e., using RA 1100 as an example).

The RA 1100 publishes its public key in its root certificate. The root certificate is a certificate that has the public key of the Registry (i.e., Certification) Authority. This public key is used to verify authentication certificates, so the root certificate must be imported into each device that will perform the information provider authentication. Typically, it is assumed a vendor or owner of data communication equipment will pre-load the root certificates of interest—including any local regional registries, all popular trade and professional registries, etc. in much the same way that Web browsers are preloaded with PKI root certificates today. Optionally, there is a way for allowing the end user to import more root certificates in the cases where the end user does business in multiple regions or is interested in a specialized registry. As understood by those skilled in the art, there is no limit to how many root public keys can be imported or the means for allowing such import.

Each interested party (i.e., registry applicant) wishing to become a registrant 1110, generates its own public/private key pair, submits the public key to the RA 1100 along with its identification information and any other required registration information and/or documentation.

If the RA 1100 determines that the interested party in fact owns or is otherwise in lawful possession of the identification information, the RA 1100 enters the identification information into the database 1100 and uses the private key of RA 1100 to sign an authentication certificate that includes the registrant's identification information and the registrant's public key. The RA 1100 therefore “vouches” that the registrant's public key is “the” public key that is bound to the registrant's identification information, and that the registrant is entitled to use that identification information.

The registrant 1110 now has a signed authentication certificate that attests to its identification information, and the registrant 1110 also has the private key that permits the registrant 1110 to validate that authentication certificate. It should be understood that the meaning of the authentication certificate is limited. The authentication certificate only signifies that the holder of the private key (which should be registrant 1110) is entitled to have its identification information displayed in the jurisdiction of the particular registration authority 1100 with which the registrant 1110 has registered.

Accordingly, in at least one embodiment of the present invention, on-demand call session party authentication functionality in accordance with the present invention relies upon registries descriptively referred to herein as “RealName registries” and associated authentication certificates (i.e., RealName certificates). Each RealName registry functions as a certificate authority for identification information. Examples of identification information in accordance with the present invention include, but are not limited to, a name by which an entity is recognized, an image specific to an entity, text specific to an entity, and a sound specific to an entity.

As depicted in FIG. 2, it is disclosed herein that RealName registries operate in effectively the same manner as trademarks registries. Each jurisdiction has its own trademarks registry, with possibly different rules for resolving ownership of a trademark and different rules for determining whether proposed identification information (e.g., a name) infringes an existing trademark. In fact, it is advantageous for RealName registries to be even more decentralized than trademark registries. For example, each jurisdiction can operate its own RealName registry, each profession can operate its own RealName registry, each trade association can operate its own RealName registry, etc. An information recipient (e.g., call session party) can pick and choose which registries they are willing to import. At a minimum, the information recipient will typically import RealName registries for the local jurisdiction and the profession that the information recipient deals with.

With the registries in place, authentication of a conference call invitee can proceed. Each registry operates as an issuer of “Certificate of approved name” as well as a database of “approved” identification information (i.e., generally referred to as RealNames). The certificates (i.e., authentication certificates) can be accomplished in many ways, but the simplest is the X.509 authentication certificates that are used for existing DNS/SSL. X.509 is a standardized public key infrastructure (PKI). In X.509 parlance, each registry operates as the “Certificate Authority” and each authentication certificate is essentially a package embedding the RealName and the public key. This package is then signed by the private key of the certificate authority. In operation, the authentication certificates are configured to include essentially any type of identification information useful for reinforcing an entity's identity.

### Call Session Party Authentication

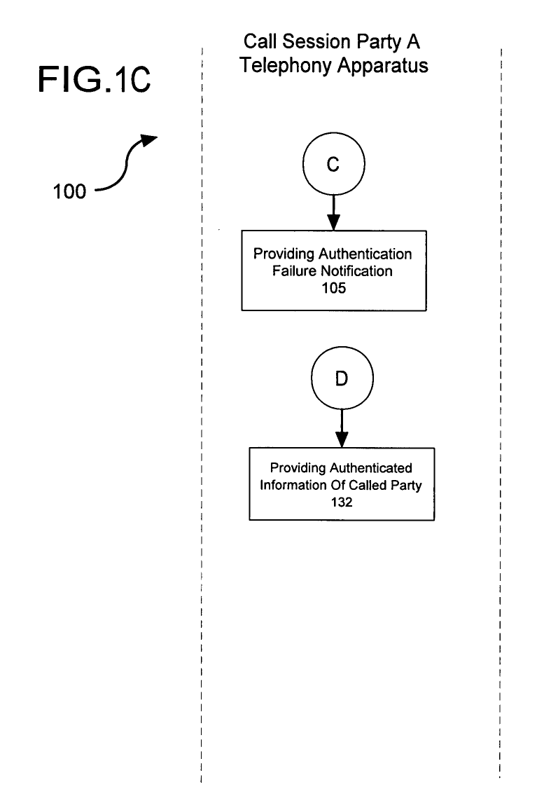

FIGS. 3-5 show embodiments of respective call session party authentication systems in accordance with the present invention. Note that call session party authentication does not require a query of the registries 1101, 1201, 1301. In one embodiment, the second call session party (i.e., Party B) presents its certificate to the first call session party (i.e., Party A), or a proxy for the Party A, as will be explained below in more detail. In one embodiment, call session party authentication (i.e., on-demand authentication of a party in a call session in accordance with the present invention) is performed after call set-up. After the data/voice path is being established, Party B sends its certificate as part of a protocol to verify ownership of the private key corresponding to the certificate. An authentication dialog can be initiated by adding extensions to VoIP signaling protocol or by exchanging a special first signaling packet.

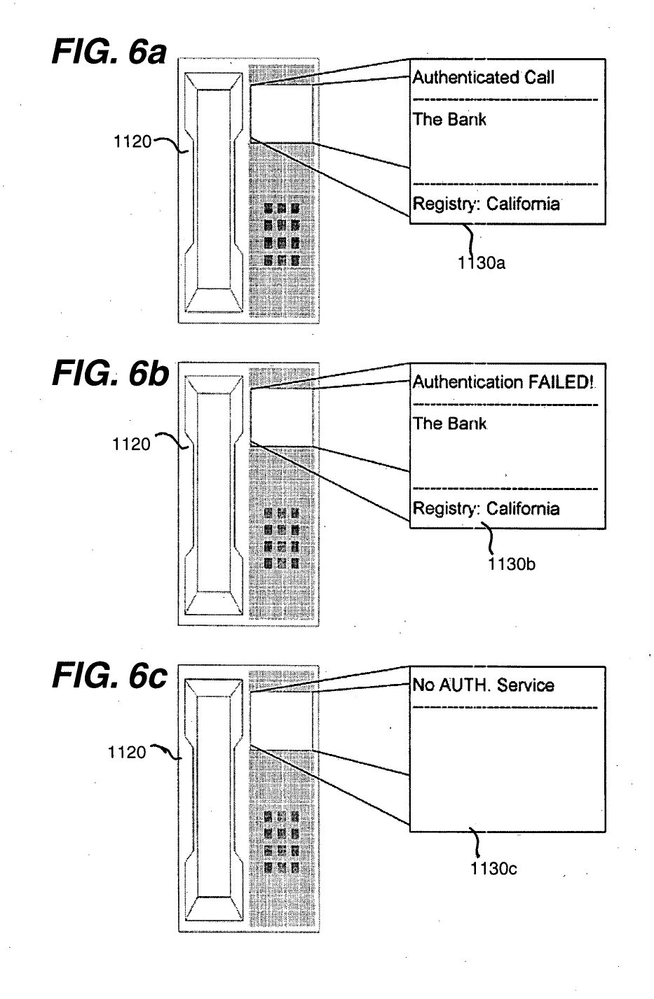

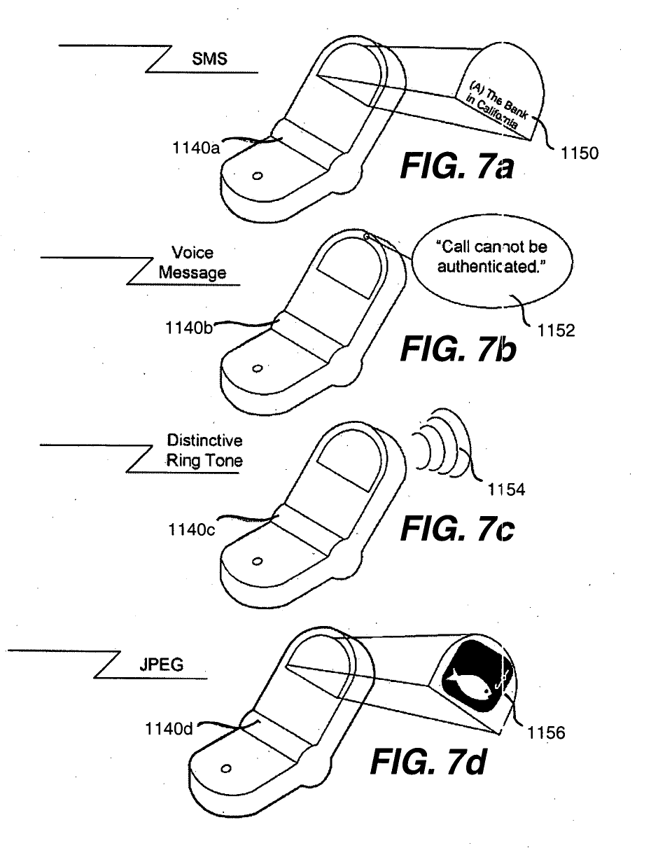

As shown in FIG. 3, in one embodiment of the present invention, the call session party authentication is performed by the Party A telephony apparatus 1110, which is for example an Internet Protocol (IP) telephone. The IP telephone 1110 is equipped with a caller authentication application 1122. This is the most secure form of call session party authentication because the party requesting authentication directly controls it. When the Party A telephony apparatus 1110 initiates a call to the Party B telephony apparatus 1120 (i.e., a registrant), call set-up (1a) proceeds through the telephone service provider network(s) in a manner well known in the art. The call set-up messages may carry regular caller information, but that information is ignored by the Party A telephony apparatus 1110 if a call session party authentication dialogue (2a) is commenced when the Party B telephony apparatus 1120 sends its authentication certificate (i.e., Party B authentication certificate), using one of the communications protocols referenced above. During such dialogue, the Party B telephony apparatus 1120 provides required authentication information (e.g., certificate proof of private key possess, identification information, etc) to the Party A telephony apparatus 1110. The call session party authentication application 1122 (i.e., authentication application) conducts the authentication dialogue with the Party B telephony apparatus 1120, facilitates authentication of the Party B authentication certificate, facilitates proof of the Party B possessing the private key corresponding to the Party B authentication certificate, and, optionally, that presented identification information matches authenticated identification information. Upon successfully authentication and verification, authenticated identification information (e.g., an authenticated name) is then provided (3a) via the Party A telephony apparatus 1110, as will be explained below with reference to FIG. 6a-6c and 7a-7d.

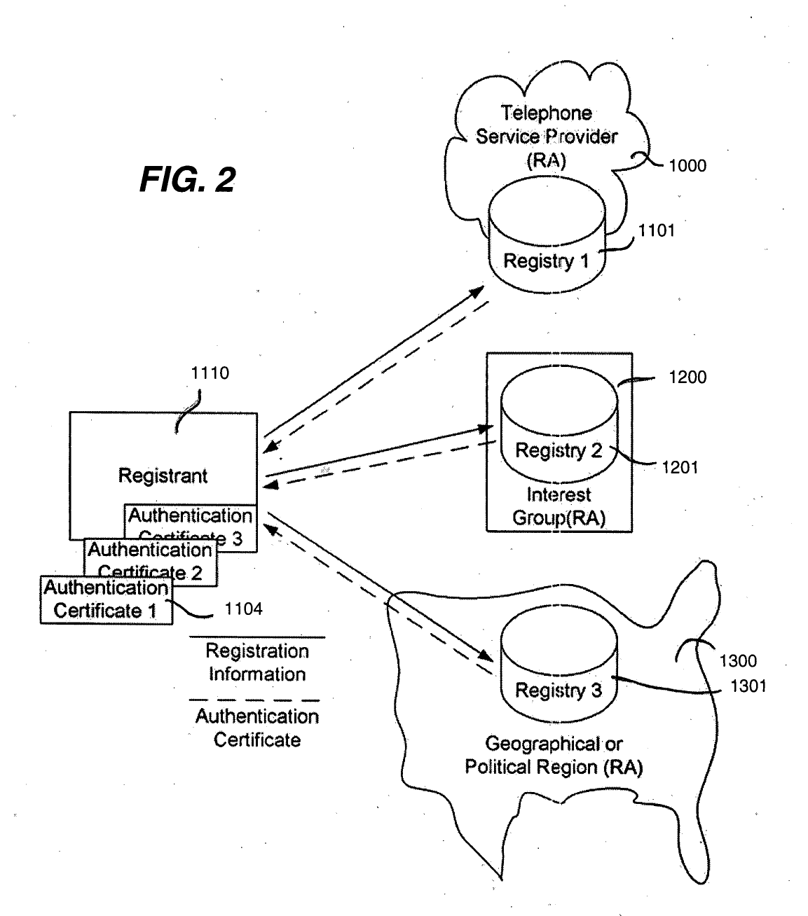

As shown in FIG. 4, in accordance with another embodiment of the present invention, the call session party authentication is performed by a public branch exchange, such as an Internet Protocol Public Branch Exchange (IP-PBX) 1116 which serves as a proxy for a call session party connected to an enterprise network 1118. In this embodiment, call set-up (1b) proceeds by conventional means through one or more networks, in this example a broadband carrier network 1114. During or after call set-up, the Party A telephony apparatus 1110 initiates a call session party authentication dialogue (2b) with Party B telephony apparatus 1120. During such dialogue, the Party B telephony apparatus 1120 provides required authentication information (e.g., certificate proof of private key possess, identification information, etc) to the Party A telephony apparatus 1110. The caller authentication application 1122 facilitates authentication of the Party B authentication certificate, facilitates proof of the Party B possessing the private key corresponding to the Party B authentication certificate, and, optionally, that presented identification information matches authenticated identification information. Upon successfully authentication and verification, authenticated identification information (e.g., an authenticated caller name) is then provided (3a) via the Party A telephony apparatus 1110, as will be explained below with reference to FIG. 6a-6c and 7a-7d.

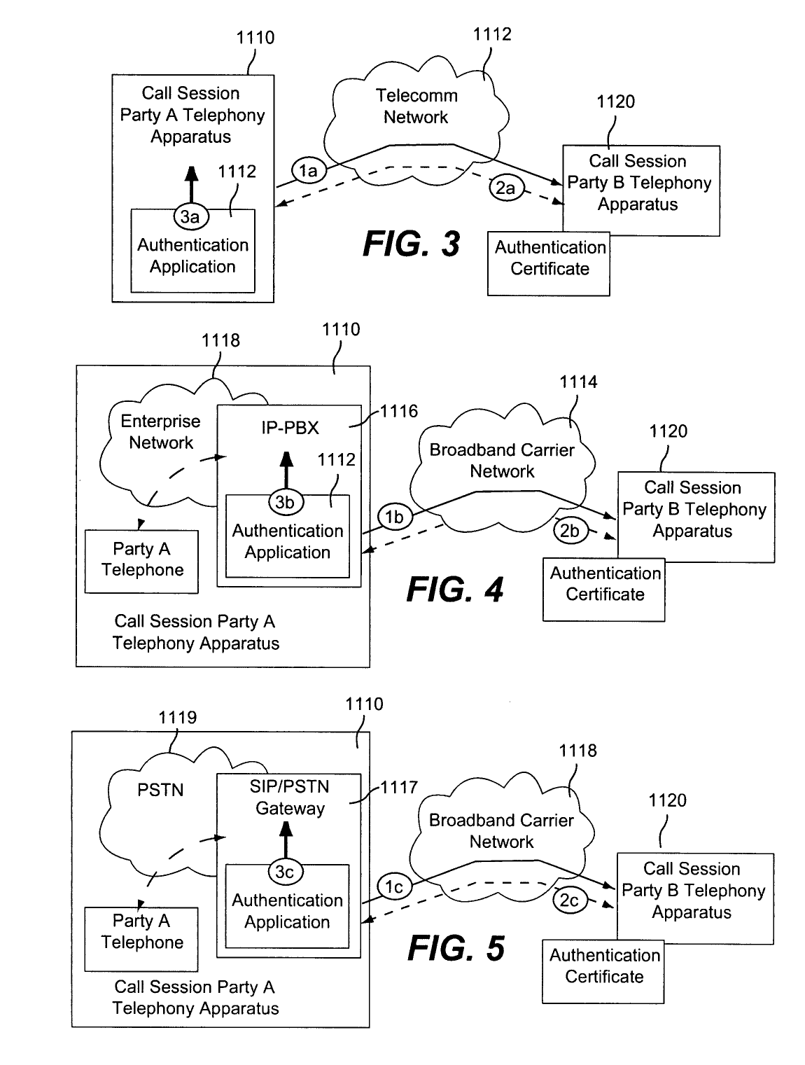

As shown in FIG. 5, in accordance with another embodiment of the present invention, the caller authentication is performed by a network gateway 1117, such as a Session Initiation Protocol (SIP)/Public Switched Telephone Network (PSTN) gateway that serves as a proxy for a call session party connected to a Public Switched Telephone Network (PSTN) 1119. In this embodiment, call set-up (1c) proceeds by conventional means through the SIP/PSTN gateway 1117 and one or more networks, in this example the broadband carrier network 1114 to the Party B telephony apparatus 1120. During or after call set-up, the Party A telephony apparatus 1110 initiates a call session party dialogue (2c) with the Party B telephony apparatus 1120. During such dialogue, the Party B telephony apparatus 1120 provides required authentication information (e.g., certificate proof of private key possess, identification information, etc) to the Party A telephony apparatus 1110. The authentication application 1122 facilitates authentication of the Party B authentication certificate, facilitates proof of the Party B possessing the private key corresponding to the Party B authentication certificate, and, optionally, that presented identification information matches authenticated identification information. Upon successfully authentication and verification, authenticated identification information (e.g., an authenticated caller name) is then provided (3a) via the Party A telephony apparatus 1110, as will be explained below with reference to FIG. 6a-6c and 7a-7d.

FIGS. 6a-6c show examples of authentication messages conveyed to a call session party in accordance with one embodiment of the invention. In these examples, the authentication messages displayed indicate whether the caller name has been authenticated; the caller name (optionally the logo, etc.); and the registry 1101, 1201, 1301 with which the caller has registered.

FIG. 6a shows an exemplary display format 1130a for authenticated call session party information. A first line of the display 1130a indicates that the call session party name has been successfully authenticated. A second line of the display 1130a displays the authenticated call session party name. The last line of the display displays the name of the RA, in this example a registry associated with the State of California.

FIG. 6b shows an exemplary display format 1130b for a call session party that could not be authenticated because authentication failed. As understood by those skilled in the art, call session party authentication may fail for any one of a number of reasons. For example: the caller may present a stolen authentication certificate for which the call session party does not have the corresponding private key; the authentication certificate cannot be validated with the public key of the CA; a communications failure may have occurred; an authentication dialogue may have been interrupted; etc. A first line of the display 1130b indicates that the call session party has not been successfully authenticated because call session party authentication has failed. A second line of the display 1130b displays the call session party name contained in the certificate, if available. The last line of the display 1130c displays the name of the registry contained in the certificate, if available. To further highlight the fact that authentication failed, the message can be displayed in a bright color, red for example, etc.

FIG. 6c shows an exemplary display format 1130c for a call session party that could not be authenticated because the call session party did not present a certificate. The first line of the display 1130c indicates that the call session party has not attempted authentication and the rest of the lines may be blank, as shown, or may display a call session party name and/or number extracted from the call set-up signaling messages, in which case the fact that authentication was not attempted should be emphasized by highlighting or blinking the no authentication service message.

As will be understood by those skilled in the art, the display formats 1130a-1130c may not always be practical or desired by a call session party. It is therefore contemplated that other forms of call authentication indications may be conveyed to a call session party. FIGS. 7a-7d illustrate alternate ways to convey an indication of authenticated identification information (i.e., call session party name) to a call session party. Although the examples shown in FIGS. 7a-7d illustrate a specific type of user device (cellular telephone) it should be understood that such indications could be conveyed to most known types of telephone devices.

As shown in FIG. 7a, a message indication successful authentication or non-successful authentication can be conveyed to a call session party using an out-of-band message sent concurrently with or after a ringing signal is sent to the user device. In this example, a Short Message Service (SMS) message is sent. The SMS message includes an indication 1150 that the call session party has been authenticated (A), or not authenticated (NA), which is not shown; and, the call session party identification information, in this example, “The Bank in California”.

As shown in FIG. 7b, alternatively an in-band voice message can be played to the first call session party to indicate whether the second call session party could be authenticated. The in-band voice message may be played to the first calling party after the second call session party answers, but before the call is “cut through”, so that the second call session party cannot forge the message. In this example, the first call session party receives a voice message 1152 indicating that the second call session party could not be authenticated.

As shown in FIG. 7c, in a further alternative a distinctive ring tone is sent to the first call session party device. One ring tone 1154 indicates authentication of the second call session party and another ring tone (not shown) indicates that the second call session party could not be authenticated.

As shown in FIG. 7d, in yet a further alternative an image, for example a .jpeg image is sent to the first call session party device to indicate whether the second call session party has been authenticated. In this example, a .jpeg image 1156 indicates that the second call session party could not be authenticated. Another .jpeg image (not shown) is used to indicate that the second call session party has been authenticated.

Referring now to processor-executable instructions in accordance with the present invention, it will be understood from the disclosures made herein that methods, processes and/or operations configured for facilitating on-demand call session party authentication functionality as disclosed herein are tangibly embodied by computer readable medium having instructions thereon that are configured for carrying out such functionality. In one specific embodiment, the instructions are tangibly embodied for carrying out one or more of the methodologies disclosed in reference to FIGS. 1-7. The instructions may be accessible by one or more data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the present invention include a compact disk, a hard drive, RAM or other type of storage apparatus that has imaged thereon instructions (e.g., a computer program) adapted for facilitating call session party authentication functionality in accordance with the present invention.

A call authentication system in accordance with the present invention can be embodied in any number of configurations. In one embodiment, such a call authentication system is a server including processor-executable instructions for carrying out at least a portion of call session party authentication functionality in accordance with the present invention. In another embodiment, such a call authentication system includes a dedicated telephone device having processor-executable instructions for carrying out at least a portion of on-demand call session party functionality in accordance with the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method, comprising:
requesting authentication of a target call session party during a call session between the target party and a call session party requesting said authentication;
receiving authentication information of the target call session party during the call session in response to requesting said authentication; and
facilitating authentication of said authentication information during the call session in response to receiving said authentication information.

2. The method of claim 1, further comprising:
triggering on-demand call session party authentication functionality prior to requesting the authenticating certificate; and
providing authentication functionality triggering signaling to telephony apparatus of the target party in response to triggering said on-demand call session party authentication functionality.

3. The method of claim 2 wherein triggering said on-demand call session party authentication functionality includes one of selecting a prescribed input element of a telephone apparatus of said requesting call session party and providing a prescribed activation code to the telephone apparatus of said requesting call session party.

4. The method of claim 2 wherein:
triggering said on-demand call session party authentication functionality includes using DTMF tone signaling for transmitting an authentication request; and
at least one of requesting said authentication and receiving said authentication information includes using out-of-band signaling for providing said authentication request and receiving said authentication information, respectively.

5. The method of claim 2 wherein:
triggering said on-demand call session party authentication functionality includes using a first type of signaling methodology for transmitting an authentication request;
at least one of requesting said authentication and receiving said authentication information includes using a second type of signaling methodology for providing said authentication request and receiving said authentication information, respectively; and
the first type of signaling methodology is different than the second type of signaling methodology.

6. The method of claim 5 wherein the first type of signaling methodology is one of a signaling methodology that transmits in a signaling path, a signaling methodology that transmits in a voice path, and a signaling methodology that transmits completely out-of-band.

7. The method of claim 1 wherein
said authentication information includes an authentication certificate; and
facilitating authentication of said authentication information includes verifying validity of the authentication certificate and verifying that the target call session party is a registrant of the authentication certificate.

8. The method of claim 7, further comprising:
providing an authentication notification in response to facilitating said authentication of said authentication information, wherein the authentication notification indicates successful authentication in response to said authentication being successful and wherein the authentication notification indicates non-successful authentication in response to said authentication not being successful.

9. A server, comprising:
processor-executable instructions for requesting authentication of a target call session party during a call session between the target party and a call session party requesting said authentication;
processor-executable instructions for receiving authentication information of the target call session party during the call session in response to requesting said authentication; and
processor-executable instructions for facilitating authentication of said authentication information during the call session in response to receiving said authentication information.

10. The server of claim 9, further comprising:
processor-executable instructions for triggering on-demand call session party authentication functionality prior to requesting the authenticating certificate; and
processor-executable instructions for providing authentication functionality triggering signaling to telephony apparatus of the target party in response to triggering said on-demand call session party authentication functionality.

11. The server of claim 10 wherein triggering said on-demand call session party authentication functionality includes one of selecting a prescribed input element of a telephone apparatus of said requesting call session party and providing a prescribed activation code to the telephone apparatus of said requesting call session party.

12. The server of claim 11 wherein:
triggering said on-demand call session party authentication functionality includes using DTMF tone signaling for transmitting an authentication request; and
at least one of requesting said authentication and receiving said authentication information includes using out-of-band signaling for providing said authentication request and receiving said authentication information, respectively.

13. The server of claim 11 wherein:
triggering said on-demand call session party authentication functionality includes using a first type of signaling methodology for transmitting an authentication request;
at least one of requesting said authentication and receiving said authentication information includes using a second type of signaling methodology for providing said authentication request and receiving said authentication information, respectively; and
the first type of signaling methodology is different than the second type of signaling methodology.

14. The server of claim 13 wherein the first type of signaling methodology is one of a signaling methodology that transmits in a signaling path, a signaling methodology that transmits in a voice path, and a signaling methodology that transmits completely out-of-band.

15. The server of claim 9 wherein
said authentication information includes an authentication certificate; and
facilitating authentication of said authentication information includes verifying validity of the authentication certificate and verifying that the target call session party is a registrant of the authentication certificate.

16. The server of claim 15, further comprising:
processor-executable instructions for providing an authentication notification in response to facilitating said authentication of said authentication information, wherein the authentication notification indicates successful authentication in response to said authentication being successful and wherein the authentication notification indicates non-successful authentication in response to said authentication not being successful.

17. A telephony network system configured to request authentication of a target call session party during a call session between the target party and a call session party requesting said authentication, to receive authentication information of the target call session party during the call session in response to requesting said authentication; and to facilitate authentication of said authentication information during the call session in response to receiving said authentication information.

18. The system of claim 17 further configured to trigger on-demand call session party authentication functionality prior to requesting the authenticating certificate and to provide authentication functionality triggering signaling to telephony apparatus of the target party in response to triggering said on-demand call session party authentication functionality.

19. The system of claim 18 wherein being configured to trigger said on-demand call session party authentication functionality includes being configured to one of selecting a prescribed input element of a telephone apparatus of said requesting call session party and providing a prescribed activation code to the telephone apparatus of said requesting call session party.

20. The system of claim 18 wherein:
being configured to trigger said on-demand call session party authentication functionality includes being configured to use DTMF tone signaling for transmitting an authentication request; and
at least one of being configured to request said authentication and receive said authentication information includes being configured to use out-of-band signaling to provide said authentication request and to receive said authentication information, respectively.

21. The system of claim 18 wherein:
being configured to trigger said on-demand call session party authentication functionality includes using a first type of signaling methodology for transmitting an authentication request;
at least one of requesting said authentication and receiving said authentication information includes using a second type of signaling methodology for providing said authentication request and receiving said authentication information, respectively; and
the first type of signaling methodology is different than the second type of signaling methodology.

22. The system of claim 21 wherein the first type of signaling methodology is one of a signaling methodology that transmits in a signaling path, a signaling methodology that transmits in a voice path, and a signaling methodology that transmits completely out-of-band.

23. The system of claim 17 wherein
said authentication information includes an authentication certificate; and
being configured to facilitate authentication of said authentication information includes verifying validity of the authentication certificate and verifying that the target call session party is a registrant of the authentication certificate.

24. The system of claim 23 further configured to provide an authentication notification in response to facilitating said authentication of said authentication information, wherein the authentication notification indicates successful authentication in response to said authentication being successful and wherein the authentication notification indicates non-successful authentication in response to said authentication not being successful.
